(19) United States
(12) Patent Application Publication
(10) Pub. No.: US 2025/0173736 A1
(43) Pub. Date: May 29, 2025

(54) Controller, System, External Server, and Notification Method

(71) Applicant: TOYOTA JIDOSHA KABUSHIKI KAISHA, Toyota-shi Aichi-ken (JP)

(72) Inventor: Junichi NISHIDA, Miyoshi-shi Aichi-ken (JP)

(73) Assignee: TOYOTA JIDOSHA KABUSHIKI KAISHA, Toyota-shi Aichi-ken (JP)

(21) Appl. No.: 18/958,581

(22) Filed: Nov. 25, 2024

(30) Foreign Application Priority Data
Nov. 29, 2023 (JP) 2023-201946

(51) Int. Cl. G06Q 30/018

(52) U.S. Cl. CPC G06Q 30/018

(57) ABSTRACT

A battery information server (controller) includes a processor (first processor) that obtains position information of an electrically powered vehicle (vehicle) and battery information based on a battery pack ID (information) of a battery pack (battery) mounted on the electrically powered vehicle. The battery information server includes a communication unit and a processor (third processor) that determines whether or not the battery pack is in conformity with battery laws and regulations in a country (area) corresponding to the position information, based on information on the battery laws and regulations set in advance for each country and the battery information. When the battery pack is determined as not being in conformity with the battery laws and regulations, the communication unit transmits a result of determination by the processor to the electrically powered vehicle.

### CROSS REFERENCE TO RELATED APPLICATIONS

This nonprovisional application is based on Japanese Patent Application No. 2023-201946 filed with the Japan Patent Office on Nov. 29, 2023, the entire contents of which are hereby incorporated by reference.

### BACKGROUND

### Field

The present disclosure relates to a controller, a system, an external server, and a notification method.

### Description of the Background Art

Japanese Patent Laying-Open No. 2012-128548 discloses a vehicle a battery of which is replaceable in a battery distributor. A battery mounted on the vehicle as a result of battery replacement includes an IC chip where an ID is stored. Code information is printed on a wrapper of the battery. The ID is read by the vehicle and transmitted to a center. The code information is read in the battery distributor and transmitted to the center. The center authenticates whether or not the ID and the code information make up an authorized set. When the ID and the code information make up the authorized set, use of the battery is permitted.

### SUMMARY

In Japanese Patent Laying-Open No. 2012-128548, whether or not the battery is an authorized product is determined, whereas whether or not the battery is in conformity with battery laws and regulations in an area where the vehicle is used is not determined.

The present disclosure was made to solve the problem above, and an object thereof is to provide a controller, a system, an external server, and a notification method that can achieve suppression of use of a battery not in conformity with battery laws and regulations in an area where a vehicle is used.

A controller according to a first aspect of the present disclosure includes a communication unit, a first processor including an information obtaining unit, a second processor that controls the communication unit, and a third processor. The information obtaining unit obtains position information of a vehicle and battery information based on information on a battery mounted on the vehicle. The third processor determines based on information on battery laws and regulations set in advance for each area and the battery information, whether the battery is in conformity with the battery laws and regulations in an area corresponding to the position information. When the battery is determined as not being in conformity with the battery laws and regulations, the communication unit transmits a result of determination by the processor to at least one of the vehicle and a terminal owned by a user of the vehicle.

In the controller according to the first aspect of the present disclosure, when the battery is determined as not being in conformity with the battery laws and regulations in the area corresponding to the position information as set forth above, the result of determination by the third processor is transmitted to at least one of the vehicle and the terminal of the user. The user can thus recognize that the battery is not in conformity with the battery laws and regulations in the area. Consequently, the user can be invited to exit from the area or to replace the battery with another battery. Use of the battery not in conformity with the battery laws and regulations in the area where the vehicle is used can thus be suppressed.

In the controller according to the first aspect, the communication unit transmits to at least one of the vehicle and the terminal, together with the result of determination, information on a facility where battery replacement with another battery in conformity with the battery laws and regulations in the area corresponding to the position information can be made. According to such a configuration, the user can be invited to replace the battery not in conformity with the battery laws and regulations mounted on an electrically powered vehicle with another battery in conformity with the battery laws and regulations.

In the controller according to the first aspect, when the battery mounted on the vehicle is an unauthorized product, the third processor determines the battery as not being in conformity with the battery laws and regulations. According to such a configuration, the user can be invited to stop using an unauthorized battery.

In the controller according to the first aspect, when the area corresponding to the position information changes, the third processor determines conformity of the battery with the battery laws and regulations corresponding to a changed area. According to such a configuration, the above determination being made in spite of no change in area where the electrically powered vehicle is located can be suppressed. Consequently, processing load imposed on the controller can be reduced.

In this case, when the vehicle stays for a prescribed period or longer in an area where the battery laws and regulations with which the battery is not in conformity are laid down, the communication unit transmits the result of determination to at least one of the vehicle and the terminal. According to such a configuration, transmission to the user, of the above result of determination made simply due to temporary (short-period) entry of the vehicle into the area can be suppressed. Consequently, processing load imposed on the controller can be reduced.

The controller according to the first aspect includes a storage where information on the battery laws and regulations corresponding to each area is stored. According to such a configuration, without externally obtaining information on the battery laws and regulations corresponding to each area, whether or not the battery is in conformity with the battery laws and regulations in each area can be determined.

A system according to a second aspect of the present disclosure includes the controller according to the first aspect and at least one of a vehicle and a terminal owned by a user of the vehicle. The controller determines based on information on battery laws and regulations set in advance for each area and battery information based on information on a battery mounted on the vehicle, whether the battery is in conformity with the battery laws and regulations in an area corresponding to position information of the vehicle, and transmits a result of determination to at least one of the vehicle and the terminal when the battery is determined as not being in conformity with the battery laws and regulations.

In the system according to the second aspect of the present disclosure, when the battery is determined as not being in conformity with the battery laws and regulations as set forth above, the result of determination is transmitted to at least one of the vehicle and the terminal. The system that can achieve suppression of use of the battery not in conformity with the battery laws and regulations in the area where the vehicle is used can thus be provided.

An external server according to a third aspect of the present disclosure includes an information obtaining unit that obtains position information of a vehicle and battery information based on information on a battery mounted on the vehicle. The external server includes a determination unit that determines based on information on battery laws and regulations set in advance for each area and the battery information, whether the battery is in conformity with the battery laws and regulations in an area corresponding to the position information.

The external server according to the third aspect of the present disclosure determines whether or not the battery is in conformity with the battery laws and regulations in the area corresponding to the position information, based on the information on the battery laws and regulations set in advance for each area and the battery information as set forth above. A user of the vehicle can thus recognize that the battery is not in conformity with the battery laws and regulations in the area, based on the result of determination by the determination unit in the external server. Consequently, the external server that can achieve suppression of use of the battery not in conformity with the battery laws and regulations in the area where the vehicle is used can be provided.

A notification method according to a fourth aspect of the present disclosure includes obtaining position information of a vehicle, obtaining battery information based on information on a battery mounted on the vehicle, determining based on information on battery laws and regulations set in advance for each area and the battery information, whether the battery is in conformity with the battery laws and regulations in an area corresponding to the position information, and transmitting a result of determination in the determining to at least one of the vehicle and a terminal owned by a user of the vehicle when the battery is determined as not being in conformity with the battery laws and regulations.

In the notification method according to the fourth aspect of the present disclosure, as set forth above, when the battery is determined as not being in conformity with the battery laws and regulations in the area corresponding to the position information, the result of determination is transmitted to at least one of the vehicle and the terminal of a user. The notification method that can achieve suppression of use of the battery not in conformity with the battery laws and regulations in the area where the vehicle is used can thus be provided.

The foregoing and other objects, features, aspects and advantages of this disclosure will become more apparent from the following detailed description of this disclosure when taken in conjunction with the accompanying drawings.

### BRIEF DESCRIPTION OF THE DRAWINGS

FIG. 1 is a diagram showing a configuration of a system according to one embodiment.

FIG. 2 is a diagram showing information stored in a memory of a battery information server according to one embodiment.

FIG. 3 is a sequence diagram showing control in the system according to one embodiment.

FIG. 4 is a diagram showing information shown on a car navigation apparatus of an electrically powered vehicle according to one embodiment.

FIG. 5 is a diagram showing information shown on a user terminal according to a modification of one embodiment.

### DESCRIPTION OF THE EMBODIMENTS

An embodiment of the present disclosure will be described in detail below with reference to the drawings. The same or corresponding elements in the drawings have the same reference characters allotted and description thereof will not be repeated.

### System Configuration

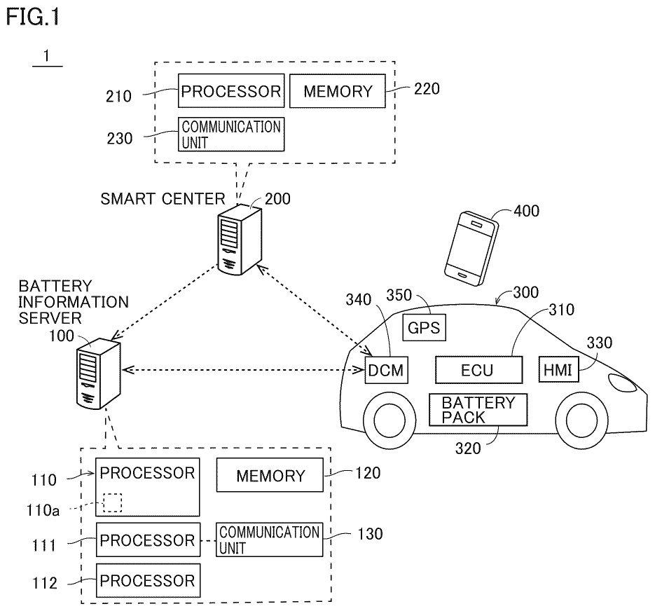

FIG. 1 is a diagram showing a configuration of a system 1 according to the present embodiment. System 1 includes a battery information server 100, a smart center 200, and an electrically powered vehicle 300. FIG. 1 shows a user terminal 400 (for example, a smartphone) owned by a user of electrically powered vehicle 300. Battery information server 100 represents an exemplary “controller” and an exemplary “external server” in the present disclosure. Electrically powered vehicle 300 and user terminal 400 represent an exemplary “vehicle” and an exemplary “terminal” in the present disclosure, respectively.

Electrically powered vehicle 300 includes, for example, a plug-in hybrid electric vehicle (PHEV), a battery electric vehicle (BEV), or a fuel cell electric vehicle (FCEV).

Electrically powered vehicle 300 includes an electronic control unit (ECU) 310, a battery pack 320, a human machine interface (HMI) apparatus 330, a data communication module (DCM) 340, and a global positioning system (GPS) module 350. Battery pack 320 represents an exemplary “battery” in the present disclosure.

Electric power for driving electrically powered vehicle 300 is stored in battery pack 320. A plurality of cells are accommodated in battery pack 320. Battery pack 320 is provided in electrically powered vehicle 300 as being replaceable with another battery pack in a battery replacement apparatus or a dealer which is not shown.

Battery pack 320 is composed, for example, of lithium iron phosphate batteries (LFP batteries). Battery pack 320 may be composed of batteries (for example, ternary batteries) other than the LFP batteries.

ID information (which will be referred to as a battery pack ID below) is set for battery pack 320. The battery pack ID is recorded in a not-shown memory or the like of battery pack 320. The battery pack ID is transmitted to DCM 340 through controller area network (CAN) communication. The battery pack ID represents exemplary “information on the battery” in the present disclosure.

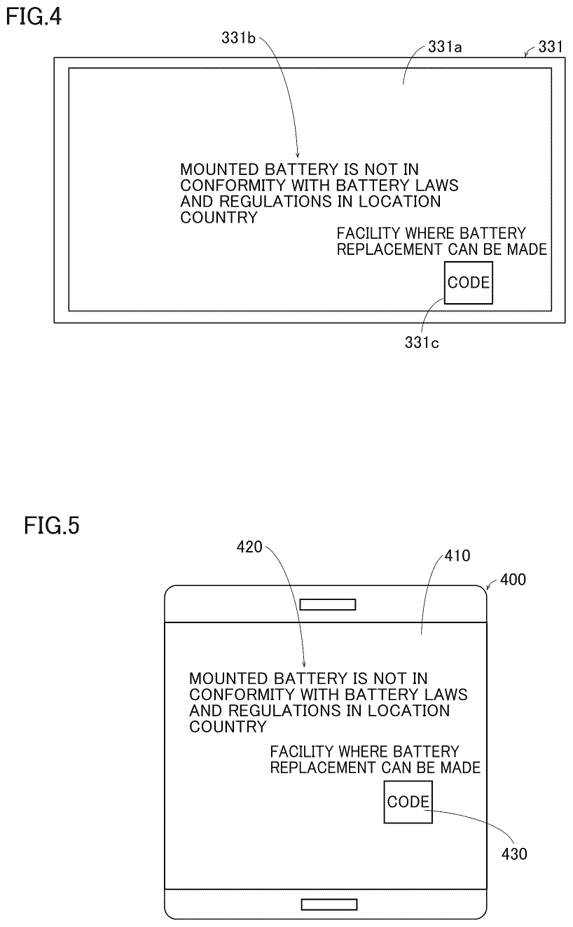

HMI apparatus 330 includes, for example, a car navigation apparatus 331 (see FIG. 4) or a not-shown speaker.

DCM 340 is configured to communicate with each of battery information server 100 (a communication unit 130 which will be described later) and smart center 200 (a communication unit 230 which will be described later). Electrically powered vehicle 300 can thus exchange various types of information with each of battery information server 100 and smart center 200 through DCM 340.

GPS module 350 receives a GPS signal transmitted from at least three (in some embodiments, at least four) satellites over electrically powered vehicle 300 and determines a position of electrically powered vehicle 300 (subject vehicle). Position information of electrically powered vehicle 300 determined by GPS module 350 is transmitted to DCM 340 through CAN communication. GPS module 350 may be contained in car navigation apparatus 331 (see FIG. 4).

ECU 310 is configured to transmit and receive information to and from battery pack 320, HMI apparatus 330, DCM 340, and GPS module 350 and to control each apparatus. Detailed control by ECU 310 will be described later.

Battery information server 100 includes a processor 110, a processor 111, a processor 112, a memory 120, and communication unit 130. Processor 110 includes an information obtaining unit 110a. Processor 111 controls communication unit 130. Processor 112 represents an exemplary “third processor” and an exemplary “determination unit” in the present disclosure. Processor 110 and processor 111 represent an exemplary “first processor” and an exemplary “second processor” in the present disclosure, respectively. Information obtaining unit 110a may represent software which is a functional feature of processor 110 expressed as a block.

Not only a program to be executed by each of processors 110, 111, and 112 but also information (for example, a map, a mathematical expression, and various parameters) to be used in the program is stored in memory 120. Memory 120 represents an exemplary “storage” in the present disclosure.

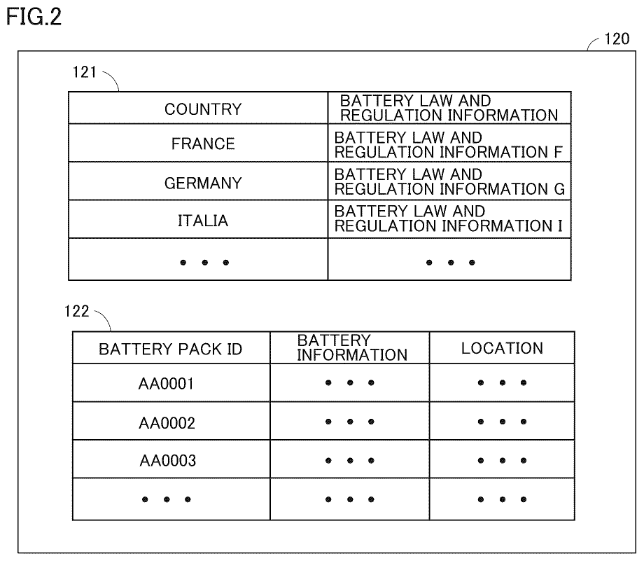

As shown in FIG. 2, information on battery laws and regulations (which may be expressed as battery law and regulation information below) set in advance for each country is stored in memory 120. Specifically, a table 121 in which a country and battery law and regulation information corresponding to the country are associated with each other is stored in memory 120. In the example shown in FIG. 2, battery law and regulation information corresponding to France is expressed as battery law and regulation information F. Battery law and regulation information corresponding to Germany is expressed as battery law and regulation information G. Battery law and regulation information corresponding to Italy is expressed as battery law and regulation information I. The battery law and regulation information includes, for example, information on a minimum value of a ratio of use of a recyclable material.

Furthermore, battery information corresponding to each of a plurality of battery packs registered in battery information server 100 is stored in memory 120. Specifically, a table 122 in which the battery pack ID, battery information corresponding to the battery pack ID, and a location of the battery pack are associated with one another is stored in memory 120. The battery information includes information on a ratio of use of a recyclable material or the like. The information on the ratio of use of the recyclable material represents exemplary “battery information” in the present disclosure.

Referring again to FIG. 1, communication unit 130 is configured to communicate with each of DCM 340 of electrically powered vehicle 300 and smart center 200 (communication unit 230 which will be described later).

Smart center 200 includes a processor 210, a memory 220, and communication unit 230. Not only a program to be executed by processor 210 but also information (for example, a map, a mathematical expression, and various parameters) to be used in the program is stored in memory 220.

Communication unit 230 is configured to communicate with each of DCM 340 of electrically powered vehicle 300 and communication unit 130 of battery information server 100. Communication unit 230 is controlled by processor 210.

The conventional controller does not determine whether or not a battery pack meets battery laws and regulations in an area where the vehicle is used. Therefore, a battery pack that fails to meet the battery laws and regulations may be used.

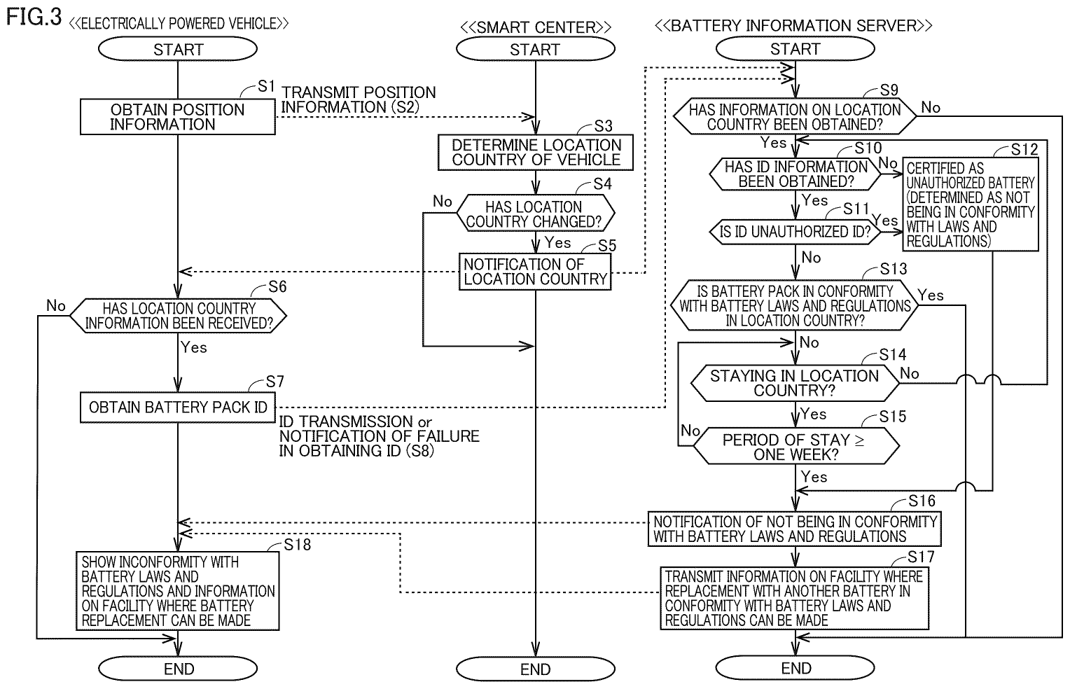

In the present embodiment, processor 112 of battery information server 100 determines whether or not battery pack 320 is in conformity with battery laws and regulations in a country corresponding to position information of electrically powered vehicle 300, based on battery law and regulation information set in advance for each country and battery information of battery pack 320. Then, when battery pack 320 is determined as not being in conformity with the battery laws and regulations, communication unit 130 of battery information server 100 transmits the result of determination by processor 112 to electrically powered vehicle 300 (DCM 340). Details will be described with reference to a sequence diagram in FIG. 3. The country represents an exemplary “area” in the present disclosure.

### Sequence Control in System

FIG. 3 is a diagram showing sequence control in system 1. Processing in electrically powered vehicle 300 shown in FIG. 3 is performed by ECU 310. Processing in smart center 200 is performed by processor 210.

In step S1, electrically powered vehicle 300 obtains position information of electrically powered vehicle 300 (itself) with GPS module 350. Processing in step S1 may be performed every prescribed period (for example, one second).

In step S2, electrically powered vehicle 300 transmits the position information obtained in step S1 through DCM 340 to smart center 200.

In step S3, smart center 200 determines a country where electrically powered vehicle 300 is located (location country) based on the position information transmitted from electrically powered vehicle 300 in step S2.

In step S4, smart center 200 determines whether or not the location country determined in step S3 has changed from the previously determined location country. Whether or not the location country of electrically powered vehicle 300 has changed from a country where electrically powered vehicle 300 is normally used (for example, a country of domicile of the user) may be determined. When the location country has changed (Yes in S4), the process proceeds to step S5. When the location country has not changed (No in S4), the process in smart center 200 ends.

In step S5, smart center 200 notifies through communication unit 220, each of electrically powered vehicle 300 and battery information server 100, of the location country determined in step S3. Thereafter, the process in smart center 200 ends.

In step S6, electrically powered vehicle 300 determines whether or not it has received the notification in step S5. When the electrically powered vehicle has received the notification in step S5 (Yes in S6), the process proceeds to step S7. When the electrically powered vehicle has not received the notification in step S5 (No in S6), the process in electrically powered vehicle 300 ends.

In step S7, electrically powered vehicle 300 obtains the battery pack ID from battery pack 320.

In step S8, electrically powered vehicle 300 transmits through DCM 340, information on the battery pack ID obtained in step S7 to battery information server 100 (communication unit 130). When electrically powered vehicle 300 has failed to obtain the battery pack ID in step S7, it notifies battery information server 100 through DCM 340 that it has failed to obtain the battery pack ID. Failure in obtaining the battery pack ID is caused by the fact that battery pack 320 is an unauthorized product, or the like. This notification may be transmitted to battery information server 100 via smart center 200.

In step S9, battery information server 100 determines whether or not processor 110 (information obtaining unit 110a) has obtained information on the location country in step S5. When battery information server 100 has obtained the information on the location country (Yes in S9), the process proceeds to step S10. When battery information server 100 has not obtained the information on the location country (No in S9), the process in battery information server 100 ends.

In step S10, battery information server 100 determines whether or not processor 110 (information obtaining unit 110a) has obtained the information on the battery pack ID in step S7. When battery information server 100 has obtained the information on the battery pack ID (Yes in S10), the process proceeds to step S11. When battery information server 100 has not obtained the information on the battery pack ID (No in S10), the process proceeds to step S12.

In step S11, battery information server 100 (processor 112) determines whether or not the received battery pack ID is an unauthorized ID. For example, when the received battery pack ID is not included in battery pack IDs in table 122 (see FIG. 2), battery information server 100 certifies the received battery pack ID as the unauthorized ID. When the battery pack ID is the unauthorized ID (Yes in S11), the process proceeds to step S12. When the battery pack ID is not the unauthorized ID (No in S11), the process proceeds to step S13.

In step S12, battery information server 100 (processor 112) certifies battery pack 320 mounted on electrically powered vehicle 300 as the unauthorized product and determines battery pack 320 as not being in conformity with the battery laws and regulations. Thereafter, the process proceeds to step S16.

In step S13, battery information server 100 (processor 112) obtains the battery information corresponding to the received battery pack ID based on information in table 122 (see FIG. 2). Battery information server 100 (processor 112) then determines whether or not battery pack 320 is in conformity with the battery laws and regulations in the location country based on the information in table 121 (see FIG. 2) and the battery information. For example, whether or not the ratio of the recyclable material corresponding to the obtained battery information is equal to or larger than a minimum value of the ratio of the recyclable material defined by the battery law and regulation information in the location country is determined. When battery pack 320 is in conformity with the battery laws and regulations (Yes in S13), the process in battery information server 100 ends. When battery pack 320 is not in conformity with the battery laws and regulations (No in S13), the process proceeds to step S14.

In step S14, battery information server 100 (processor 112) determines whether or not electrically powered vehicle 300 stays in the location country (the country corresponding to the battery law and regulation information in S13). For example, when battery information server 100 has not newly received the notification in step S5, it determines electrically powered vehicle 300 as staying in the location country. When electrically powered vehicle 300 stays in the location country (Yes in S14), the process proceeds to step S15. When electrically powered vehicle 300 does not stay in the location country (No in S14), the process returns to step S10.

In step S15, battery information server 100 (processor 112) determines whether or not a period of stay of electrically powered vehicle 300 in the location country is equal to or longer than one week. For example, when one week or longer has elapsed since reception of the notification in step S5, battery information server 100 determines that the period of stay of electrically powered vehicle 300 in the location country is equal to or longer than one week. When the period of stay in the location country is equal to or longer than one week (Yes in S15), the process proceeds to step S16. When the period of stay in the location country is shorter than one week (No in S15), the process returns to step S14. A criterion in step S15 does not have to be set to one week. A period other than one week may be defined as the criterion so long as the period can serve as a threshold for determination as temporary stay of electrically powered vehicle 300 in the location country for a trip or the like.

In step S16, battery information server 100 (processor 111) transmits through communication unit 130 to electrically powered vehicle 300, information indicating that battery pack 320 is not in conformity with the battery laws and regulations. The information may be transmitted to electrically powered vehicle 300 via smart center 200.

In step S17, battery information server 100 (processor 111) transmits through communication unit 130 to electrically powered vehicle 300, information on a facility where battery replacement with another battery pack in conformity with the battery laws and regulations in the location country can be made. The information may be transmitted to electrically powered vehicle 300 via smart center 200. The process in steps S9 to S17 represents an exemplary “notification method” in the present disclosure.

In step S18, electrically powered vehicle 300 shows each of the information in step S16 and the information in step S17 on car navigation apparatus 331 (see FIG. 4).

As shown in FIG. 4, a message 331b “mounted battery is not in conformity with battery laws and regulations in location country” is shown on a display screen 331a of car navigation apparatus 331. In addition, a code 331c corresponding to a facility where battery replacement with another battery pack in conformity with the battery laws and regulations in the location country can be made is shown on display screen 331a. When the user selects code 331c in display screen 331a, a homepage (a screen for reservation of battery replacement in the facility) or the like of the facility may be shown. The facility corresponding to code 331c may be a facility located closest to electrically powered vehicle 300. Code 331c may be, for example, a QR code® or a bar code.

In addition, when the user uses the facility corresponding to code 331c, the user may be given an incentive. The incentive includes, for example, waiving (or discount) of cost for battery replacement.

As set forth above, in the present embodiment, battery information server 100 (processor 112) determines whether or not battery pack 320 is in conformity with the battery laws and regulations in the country corresponding to the position information of electrically powered vehicle 300, based on the battery law and regulation information set in advance for each country and the battery information of battery pack 320. When battery pack 320 is determined as not being in conformity with the battery laws and regulations, battery information server 100 (communication unit 130) transmits the result of determination to electrically powered vehicle 300. The user of electrically powered vehicle 300 who uses battery pack 320 not in conformity with the battery laws and regulations in the location country can thus be notified that battery pack 320 is not in conformity with the battery laws and regulations. Consequently, continued use by the user, of battery pack 320 not in conformity with the battery laws and regulations can be suppressed. Use of battery pack 320 not meeting the battery laws and regulations in the area where electrically powered vehicle 300 is used can thus be suppressed.

Though the embodiment shows the example in which the information on the facility where battery replacement can be made is given to the user together with the notification that battery pack 320 is not in conformity with the battery laws and regulations (the result of determination), the present disclosure is not limited thereto. The user may simply be notified that battery pack 320 is not in conformity with the battery laws and regulations.

Though the embodiment shows the example in which the user is notified that battery pack 320 is not in conformity with the battery law and regulation information when battery pack 320 is an unauthorized product, the present disclosure is not limited thereto. The user may be notified that battery pack 320 is the unauthorized product or battery pack 320 has not been registered in battery information server 100 when battery pack 320 is the unauthorized product.

Though the embodiment shows the example where conformity of battery pack 320 is determined when the country (area) where electrically powered vehicle 300 is located changes, the present disclosure is not limited thereto. For example, conformity of battery pack 320 may be determined each time the position information of electrically powered vehicle 300 is obtained.

Though the embodiment shows the example where notification that battery pack 320 is not in conformity with the battery laws and regulations is given when electrically powered vehicle 300 stays for one week (prescribed period) or longer in the country (area) where battery pack 320 is not in conformity with the battery laws and regulations, the present disclosure is not limited thereto. The notification that battery pack 320 is not in conformity with the battery laws and regulations may be given at the timing of entry of electrically powered vehicle 300 into the country (area) where battery pack 320 is not in conformity with the battery laws and regulations.

Though the embodiment shows the example where the battery law and regulation information corresponding to each country (area) is stored in memory 120 of battery information server 100, the present disclosure is not limited thereto. Battery information server 100 may receive from a cloud, the battery law and regulation information stored on the cloud.

Though the embodiment shows the example where battery pack 320 not being in conformity with the battery laws and regulations is shown on car navigation apparatus 331, the present disclosure is not limited thereto. Battery pack 320 not being in conformity with the battery laws and regulations may be shown on user terminal 400. Battery pack 320 not being in conformity with the battery laws and regulations may be shown on both of car navigation apparatus 331 and user terminal 400.

In an example shown in FIG. 5, a message 420 “mounted battery is not in conformity with battery laws and regulations in location country” is shown on a display screen 410 of user terminal 400. In addition, a code 430 indicating information on a facility where battery replacement with another battery pack in conformity with the battery laws and regulations in the location country can be made is shown on display screen 410.

Though the embodiment shows the example where electrically powered vehicle 300 is provided in system 1, the present disclosure is not limited thereto. Instead of electrically powered vehicle 300, user terminal 400 may be provided in system 1. In this case, electrically powered vehicle 300 shown in FIG. 3 is controlled by user terminal 400.

Though the embodiment shows the example where whether or not battery pack 320 where electric power for driving electrically powered vehicle 300 is stored is in conformity with the battery laws and regulations is determined, the present disclosure is not limited thereto. Whether or not an auxiliary battery or a portable battery of electrically powered vehicle 300 is in conformity with the battery laws and regulations may be determined.

Though the embodiment shows the example where whether or not battery pack 320 is in conformity with the battery laws and regulations is determined, the present disclosure is not limited thereto. Whether or not each of a plurality of cells accommodated in battery pack 320 is in conformity with the battery laws and regulations may be determined. In this case, an individual ID is set for each cell.

Though the embodiment shows the example where battery information server 100 determines whether or not battery pack 320 is in conformity with the battery laws and regulations, the present disclosure is not limited thereto. The ECU of the electrically powered vehicle may determine whether or not battery pack 320 is in conformity with the battery laws and regulations. In this case, electrically powered vehicle 300 may externally obtain the battery law and regulation information corresponding to each country (area).

Though the embodiment shows the example where whether or not battery pack 320 is in conformity with the battery laws and regulations set in advance for each country is determined, the present disclosure is not limited thereto. For example, whether or not battery pack 320 is in conformity with the battery laws and regulations set for each different area in one country may be determined.

Though the embodiment shows the example where information on the location of the battery pack is stored in memory 120 of battery information server 100, the present disclosure is not limited thereto. The information on the location of the battery pack does not have to be stored in memory 120.

Though the embodiment shows the example where the notification that battery pack 320 is not in conformity with the battery laws and regulations and the notification of a facility where battery replacement can be made are shown on car navigation apparatus 331, the present disclosure is not limited thereto. The notification may be given by sound from a speaker or the like.

Though the embodiment shows the example where system 1 includes smart center 200 and battery information server 100, the present disclosure is not limited thereto. A control system may include a single server which is integration of smart center 200 and battery information server 100.

Though the embodiment shows the example where the battery pack ID is transmitted from electrically powered vehicle 300 to battery information server 100, the present disclosure is not limited thereto. The battery information (for example, the information on the ratio of use of the recyclable material) may be transmitted from electrically powered vehicle 300 to battery information server 100.

Though the embodiment shows the example where processor 110, processor 111, and processor 112 that carry out different control are provided in battery information server 100, the present disclosure is not limited thereto. For example, only a single processor that can carry out control by each of processor 110, processor 111, and processor 112 may be provided in the battery information server.

Control in the embodiment above and various modifications above may be carried out as being combined.

Though an embodiment of the present disclosure has been described, it should be understood that the embodiment disclosed herein is illustrative and non-restrictive in every respect. The scope of the present disclosure is defined by the terms of the claims and is intended to include any modifications within the scope and meaning equivalent to the terms of the claims.

What is claimed is:

1. A controller comprising:
a communication unit;
a first processor including an information obtaining unit;
a second processor that controls the communication unit; and
a third processor, wherein
the information obtaining unit obtains position information of a vehicle and battery information based on information on a battery mounted on the vehicle,
the third processor determines based on information on battery laws and regulations set in advance for each area and the battery information, whether the battery is in conformity with the battery laws and regulations in an area corresponding to the position information, and
when the battery is determined as not being in conformity with the battery laws and regulations, the communication unit transmits a result of determination by the third processor to at least one of the vehicle and a terminal owned by a user of the vehicle.

2. The controller according to claim 1, wherein
the communication unit transmits to at least one of the vehicle and the terminal, together with the result of determination, information on a facility where battery replacement with another battery in conformity with the battery laws and regulations in the area corresponding to the position information can be made.

3. The controller according to claim 1, wherein
when the battery mounted on the vehicle is an unauthorized product, the third processor determines the battery as not being in conformity with the battery laws and regulations.

4. The controller according to claim 1, wherein
when the area corresponding to the position information changes, the third processor determines conformity of the battery with the battery laws and regulations corresponding to a changed area.

5. The controller according to claim 4, wherein
when the vehicle stays for a prescribed period or longer in an area where the battery laws and regulations with which the battery is not in conformity are laid down, the communication unit transmits the result of determination to at least one of the vehicle and the terminal.

6. The controller according to claim 1, further comprising a storage where information on the battery laws and regulations corresponding to each area is stored.

7. A system comprising:
the controller according to claim 1; and
at least one of a vehicle and a terminal owned by a user of the vehicle, wherein
the controller
determines based on information on battery laws and regulations set in advance for each area and battery information based on information on a battery mounted on the vehicle, whether the battery is in conformity with the battery laws and regulations in an area corresponding to position information of the vehicle, and
transmits a result of determination to at least one of the vehicle and the terminal when the battery is determined as not being in conformity with the battery laws and regulations.

8. An external server comprising:
an information obtaining unit that obtains position information of a vehicle and battery information based on information on a battery mounted on the vehicle; and
a determination unit that determines based on information on battery laws and regulations set in advance for each area and the battery information, whether the battery is in conformity with the battery laws and regulations in an area corresponding to the position information.

9. A notification method comprising:
obtaining position information of a vehicle;
obtaining battery information based on information on a battery mounted on the vehicle;
determining based on information on battery laws and regulations set in advance for each area and the battery information, whether the battery is in conformity with the battery laws and regulations in an area corresponding to the position information; and
transmitting a result of determination in the determining to at least one of the vehicle and a terminal owned by a user of the vehicle when the battery is determined as not being in conformity with the battery laws and regulations.
